(19) United States
(12) Patent Application Publication
(10) Pub. No.: US 2005/0165521 A1
(43) Pub. Date: Jul. 28, 2005

(54) Precision turf treatment

(76) Inventor: Steve S. Gruhn, Spirit Lake, IA (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/764,491

(22) Filed: Jan. 27, 2004

(51) Int. Cl. G05D 1/00

(52) U.S. Cl. 701/30; 701/23

(57) ABSTRACT

Golf courses and other turf grass areas can be treated in a manner that maintains turf grass in a manner closely related to the specific needs of the turf. A piece of turf maintenance equipment (chemical applicator, mower, aerator, etc) is operatively linked to a computer database and local positioning system for the tractor. The database contains a map of the treatment area that contains a variety of attribute information pertinent to proper maintenance of the turf grass. This map is linked to the location system coordinate output so that a maintenance control computer can control operation of the attached maintenance device as the operator drives over the course.

### FIELD OF THE INVENTION

The present invention relates to a system that includes hardware, software, and technique for the care and treatment of golf courses, sod farms, estates, parks, and other lands covered by more than 3 acres of grass or tender groundcover plants. More specifically, turf maintenance is coupled to a local positioning system, such as a global positioning system (GPS), pseudolites, or cellular telephone communication systems, and a computer that has been pre-programmed with a maintenance control program. The control program interacts with a database containing information with an analysis of the area to be treated as well as characteristics of the attached maintenance equipment for proper management.

### BACKGROUND OF THE INVENTION

Precision agriculture is a fairly new system for treating commodity crop fields by coordinating local soil needs (as determined by a preliminary soil analysis) with controlled amounts and types of agrichemical fertilizer. See, U.S. Pat. Nos. 6,199,000 and 6,236,907. Precision agriculture promises to target the type and amount of agrichemical agent to the specific needs of the underlying soil and growing plants so as to reduce the overall amount of applied chemicals and possibilities for runoff associated therewith.

In preparation for precision agricultural management, a preliminary soil analysis is performed at identified GPS coordinates to form a characteristics map of a target field. A spreader device with one or more bins of treatment chemicals is linked to a computer control system and GPS tracking system. As the tractor progresses over the field, the computer consults the GPS system for position information, looks up the soil analysis or needs information for that position, and sends appropriate control signals to open or close dispensing valves on the agrichemical bins and/or adjusts the rate at which agrichemicals are dispensed from the bin(s) at such a location. Software and systems for precision agriculture are commercially available from the SoilTeq division of Agco, a company with offices at Minnetonka, Minn.

Fields typically treated with precision agriculture methods are used for growing commodity crops (corn, soybeans, wheat, etc.) and are characterized by sizes of at least 100 acres and rows of commodity crops that are separated by clear lanes of soil. Fields used for growing such commodity crops typically show few surface features.

Golf courses, sports fields, and similar fields of tender groundcover plants also have varying soil types and disparate treatment needs for the plants growing thereon depending on location. Unfortunately, precision agriculture techniques for commercial crop farms are not directly used for fields of groundcover plants: the tractors and agrichemical spreaders weigh too much and have too small of a tire “footprint” (e.g., too high of a pressure on the ground) or too aggressive of a tread pattern (small contact areas with large openings therebetween) to avoid damage to grass and similar groundcover. Golf courses, estates, parks, and similar areas are also characterized by various surface obstructions (benches, trash cans, and the like), buildings, surface contours, planting areas, and relatively narrow green areas. Commercial agriculture spreaders are designed to distribute the treatments over relatively large, fan-shaped areas that are ill suited to the efficient usage of treatment agents in smaller areas.

It would be desirable to have a system for applying the techniques of precision agriculture, and the efficiencies associated with applying only so much treatment agent as is needed for the underlying soil and turf grasses growing therein.

Golf courses also face treatment needs that are not found in commercial agriculture. In particular, golf courses have various types of turf (tee boxes, fairways, greens, and rough) with trees of various degrees of maturity and water hazards. Each of these factors requires different types of treatment (or lack thereof) and cultivates or is susceptible to different types of pests that requires skill and judgment for effective management. Often, groundskeepers must rely on poorly documented historical knowledge and personal experience of turf diseases, soil deficiencies, and/or pest infestations for management of the course grounds. When one considers the employee turnover rate of skilled golf course groundskeeping personnel and the associated loss of historical information, the responsibilities facing a new groundskeeper are daunting.

It would be desirable to have a golf course groundskeeping system that would allow the creation of accurate historical treatment information for the course grounds. It would also be advantageous to have a record of grounds treatments that could be created automatically and allow analysis of the health challenges to the grounds (disease, pest populations, insufficient or excessive growth, and the like) so that associations can be formed that will enhance vitality of the grounds without excessive cost.

### SUMMARY OF THE INVENTION

It is an objective of the invention to provide a system and equipment for the precision application of turf treatment agents without damage to the plants or waste of applied treatment agent.

It is a further objective of the invention to provide a system for precision turf grass treatments that allows for automated record-keeping and historical analysis.

In accordance with these and other objectives of the invention that will become apparent from the description herein, a system for precision treatment of turf grass areas comprises:
a. a utility tractor having a plurality of wheels distributed at a front end and a rear end of said tractor,
b. a turf maintenance device hitched to said tractor at a location on said tractor sufficient to distribute weight of said maintenance device between said wheels and prevent damage to turf on said course,
c. a position location system that displays local position of said utility tractor relative to a treatment area and displays said location to an operator of said tractor, and
d. a maintenance control computer system that is in communication with said location system wherein said computer application control system (i) records position information in said target treatment area, (ii) correlates said position information with stored data that identifies the turf treatment needs at said location for said maintenance device, and (iii) sends control signals to said maintenance device for controlling operation of said maintenance device at said location.

A method for treating turf on a golf course according the invention comprises: moving a turf maintenance device over turf on a golf course and modifying operation of said maintenance device according to device position on said course as determined by a local position system and coordinates of a map identifying attributes of said course at said location. Suitable maintenance devices include chemical applicators for liquid or granulated agents, lawn mowers, and turf aeration equipment. Exemplary course attributes that can affect operation of the maintenance equipment include: soil compaction (density), soil type, nutrient analysis, history of pest or disease, moisture, exposure to direct sunlight, drainage, slope, desired turf type or height, and the like.

In a specific embodiment pertinent to the application of treatment agents, a method for treating turf in golf courses, parks, sod farms and similar turf growing areas includes the step of:

applying at least one turf treatment agent in a target location at a rate and over an area corresponding to stored computer information that identifies the course attributes at said target location, wherein application of said turf treatment agent in said area is controlled by a computer system responding to location information that controls the quantity of the applied turf treatment agent thru a spreader controllably linked to said computer and based on (a) location information and (b) a map of course attributes that is stored within said computer.

The equipment and method of use of the invention provide a commercial system for treating turf growing areas with the precision maintenance equipment. Aeration patterns and depth of aeration core can be precisely performed from soil compaction and soil type information. Sectional mowers can be pulled by the tractor and automatically controlled for rapid mowing with high precision. Chemical treatment agents in liquid or granular form can be applied at a rate and of a quality that corresponds to chemical analysis and historical record information of relatively small areas of turf in the target area. Such a system reduces or eliminates the application of too much or too little treatment agent or the wrong type of treatment agent. Local runoff into waterways or water bodies should be minimized or eliminated. Correspondingly, the costs associated with treatment agents should be reduced with enhanced efficacy.

### BRIEF DESCRIPTION OF THE DRAWINGS

FIG. 1 shows a frontal view of a utility tractor with a front end fork lift and which is coupled to a variable rate spreader.

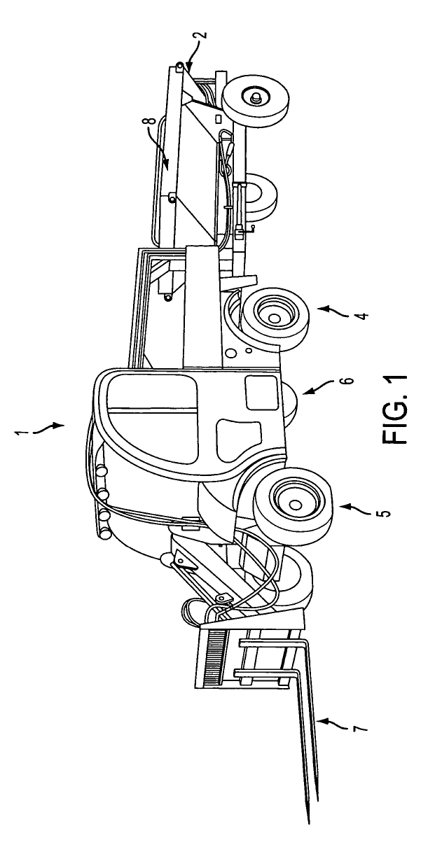

FIG. 2 is a side view of the utility tractor and spreader in FIG. 1 showing a load-bearing hitch connection above and between the front and rear wheels of the utility tractor.

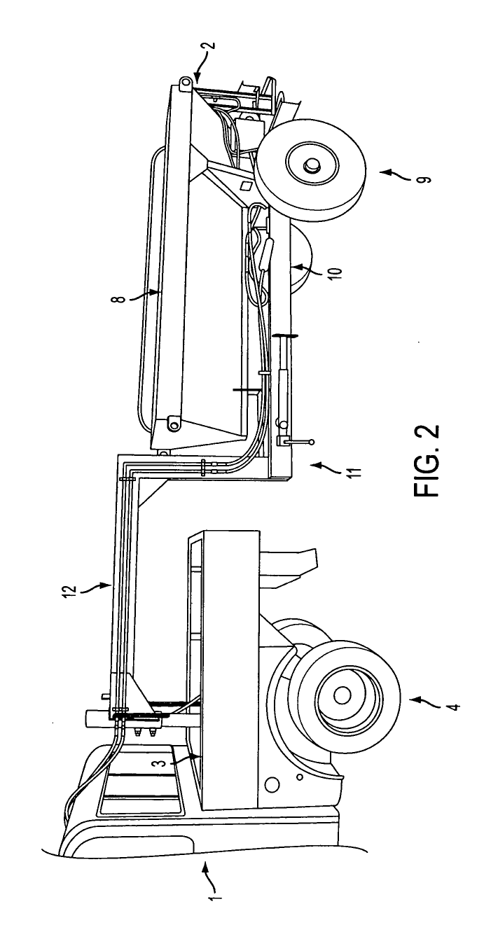

FIG. 3 illustrates a first side of the hitch connection and hydraulic supply lines for operation of the variable rate spreader.

FIG. 4 shows a second side of the hitch connection showing the computer control linkages to the control node associated with the computer control system of the invention.

FIG. 5 is a view from the port side of a first spreader plate beneath the variable speed belt that transports components from the bin to the spreader plates.

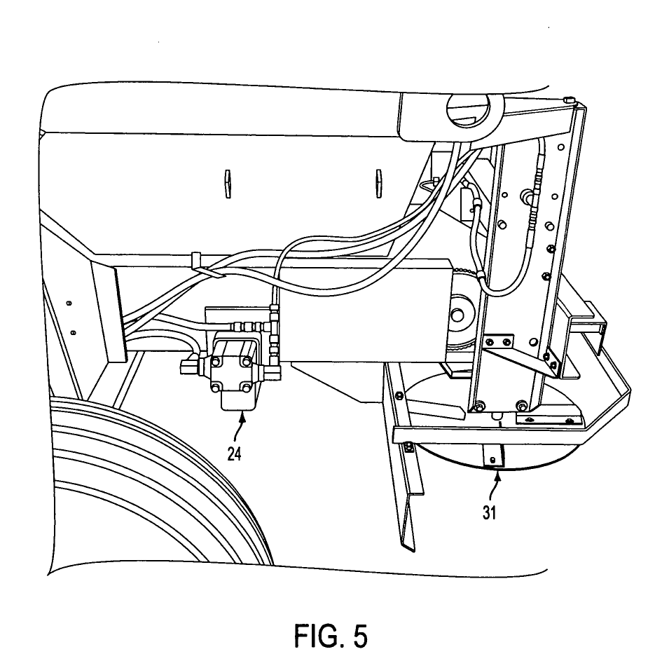

FIG. 6 shows a rear view of the spreader with the bin discharge, the transport belt, and a pair of oppositely rotatable spreader plates.

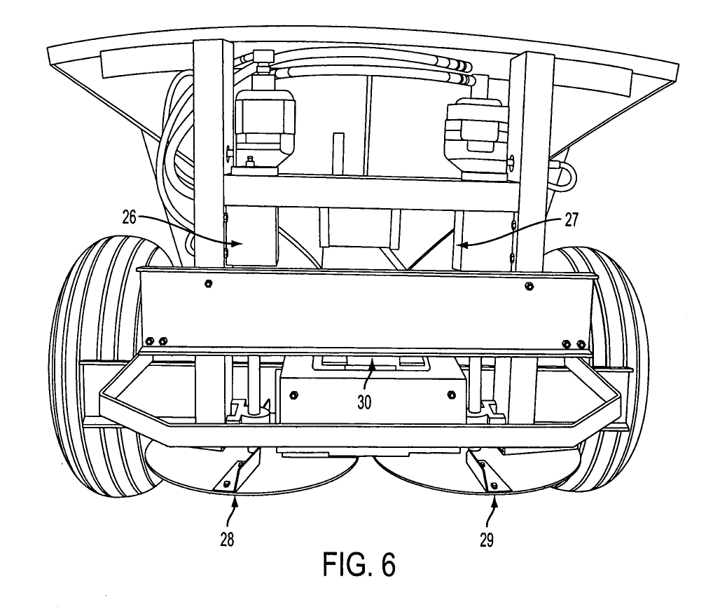

FIG. 7 is a starboard side view showing the control unit of the variable speed belt as well as a second spreader plate beneath the bin.

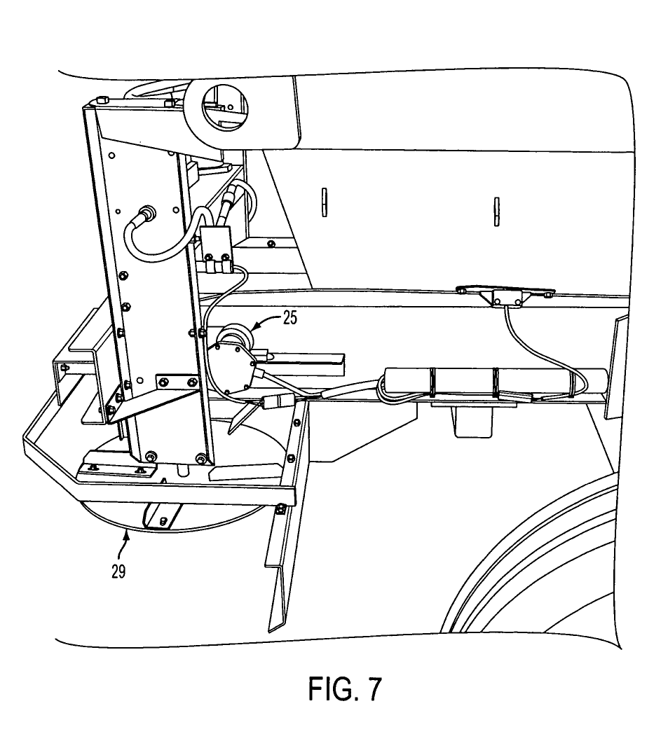

FIG. 8 shows a sample layout of the computer application control system components within the operator cab of a utility tractor.

FIG. 9 is sample screen shot of a display that an operator might see during a treatment of a golf course fairway.

### DETAILED DESCRIPTION OF THE BEST MODES OF THE INVENTION

In accordance with the invention, the turf treatment system of the invention includes a tractor that is hitched to one or more pieces of controllable turf maintenance equipment and a local position system for precision maintenance of mapped areas of turf-growing facilities. Each piece of equipment is identified with a programmable node coupling that can be linked to a computer-based maintenance control system. The computer system uses the information within the equipment node on the attached equipment to identify the attached equipment, its controllable components, and functional status. This node information is associated by the computer with one or more databases of stored course attribute information and local position information. The management control system then controls operation of the attached maintenance equipment based on the tractor's location within the treatment area and in response to an ideal set of corrections based on the stored “map” of attributes for that treatment area.

Although various methods and apparatus will be described herein with particular reference to GPS systems, it should be appreciated that the teachings are equally applicable to location tracking systems which utilize pseudolites, cellular telephone systems, or a combination thereof. Pseudolites are ground- or near ground-based transmitters which broadcast a pseudorandom (PRN) code (similar to a GPS signal) modulated on an L-band (or other frequency) carrier signal, generally synchronized with GPS time. Each transmitter may be assigned a unique PRN code so as to permit identification by a remote receiver. Pseudolites are useful in situations where GPS signals from an orbiting satellite might be unavailable, such as tunnels, mines, buildings or other enclosed areas or in areas of significant foliage. The term “satellite” , as used herein, is intended to include pseudolites, equivalents of pseudolites, cellular telephone communication systems, and the term GPS signals, as used herein, is intended to include GPS-like signals from pseudolites, cellular telephone systems, or equivalents thereof.

The invention and the equipment described herein are presented in the context of a treatment for golf courses. Those skilled in the art will appreciate that the system and method of treating golf course turf grass can also be adapted for use on a variety of fields and facilities that have significant amounts of turf grass, e.g., parks, sports facilities, driving ranges, putting greens, sod farms, historical “villages” and similar facilities.

Golf courses are unique in that tournament caliber courses are often characterized by varied types of turf—tee boxes, fairways, “rough”, and specialized grass for the greens—along with specific parameters for optimal soil compaction, soil type, fertilization, alkalinity, pest/disease prevention, etc. for optimum growth of these turf grasses. Additionally, golf courses require grass heights to be maintained within several specific height ranges for optimal challenge. Varied vertical obstacles located throughout the course add maintenance challenges and may include benches, signs, refuse cans, storage sheds and similar constructions that might affect the effective distribution of applied liquid or granular treatments. Golf courses also have varied terrain features, e.g., sand traps and water bodies that either do not need or should be protected from direct treatment or runoff of turf treatment agents, e.g., fertilizers, insecticides, fungicides, herbicides, and the like. The underlying business of golf courses requires an unbroken history of excellent turf quality that raises the stakes associated with treatment errors.

The tractor used in the present treatment system should be suitable in length, width, weight, turning radius, tire tread, etc. for the needs of treating a golf course or other turf-growing area. A suitable model of tractor that can be adapted for use in the present system is the Toolcat™ 5600 utility tractor that is commercially available from Bobcat Company in Wells Fargo, N. Dak. USA. The 5600 has a 44 HP (33 kW) diesel engine with a length of about 3.7 m, a height of about 2 m, a turning diameter of about 5 m, and a cargo box maximum load of 907 kg. A rear trailer hitch is available for towing carts and equipment. This tractor has adequate power and maneuverability for use on mid-sized professional caliber golf courses of average maturity, fairway width, terrain, and obstacle placement.

The maintenance tractor used in the present invention is outfitted with an onboard computer and local position system. See, U.S. Pat. No. 6,195,604 the disclosure of which is herein incorporated by reference. Such a system will generally include and operator cab mounted between front and rear tires, with conventional power, steering, and drive train systems. The maintenance control computer is preferably mounted within the operator cab for convenient viewing of the computer display and manipulation of the relevant control knobs, switches, joysticks, and similar input devices.

The tires used on any utility tractor that operates on golf course turf should be configured to distribute the tractor weight evenly over tires in a sufficiently large “footprint” or “contact patch” to avoid damage to growing turf. Preferably, the tires on the tractor as well as any spreader that is pulled behind the tractor would have a tire width (sidewall to sidewall) within the range of 8-14 inches, and more preferably within the range of 9-12 inches to provide a sufficiently large “footprint” at recommended inflation and maximum load (tractor plus fully loaded towed spreader) to minimize or avoid damage to turf grass underneath the tire while the utility tractor is used to pull a fully loaded spreader. In order to provide adequate stiffness and pulling performance, the sidewall of the tires used on the utility tractor should be within the range of 4-8 inches as measured from the tread to the rim when mounted on the tractor and the spreader is empty. Thus, the aspect ratio (sidewall height to tire width) of a preferred utility tractor tire for use in the present invention is within the range from about 0.35 to about 1. A particularly preferred aspect ratio for the utility tractor tire is within the range from about 0.4 to 0.75.

The utility cart used in the present invention is modified by adding a maintenance device hitch to the bed behind the operator cab at a point above and between the tractor wheels. Locating the hitch in the bed above the tractor's rear wheels or above a point that is between the front and rear tractor wheels to allow the “tongue weight” from the spreader to be more evenly distributed among the wheels of the cart and reduces the weight applied by each tire. Additionally, the forward hitch reduces the overall length of the tractor/spreader combination and preserving an even weight distribution on the cart that preserves the ease of steering the cart when the spreader is fully loaded.

One or more maintenance devices are recognized by the maintenance computer through a programmable device node associated with each maintenance device. This node device is programmed to contain information that identifies the device and its controllable components. The node also provides the logic controller and interface that allows the maintenance computer system to send appropriate control signals to each component for effecting control over the device. Examples of useful maintenance devices include: (a) turf aerators with one or more depth-adjustable core aeration rollers linked end-to-end for aerating a width of turf; (b) height and speed-adjustable grass mowing sections also positioned end-to-end for mowing a width of grass; (c) a boom sprayer for liquid agrichemicals wherein each arm of the sprayer can be controlled as one section or in multiple sections down to nozzle by nozzle control with a solenoid on/off valve associated with each nozzle and by control over the feed pressure supplying each line to the sprayer arm; and (d) a granular spreader that supplies granulated turf agents (e.g., fertilizer, pesticide, fungicide, lime, seed, and the like) from one or more supply bins.

As more fully described with reference to the attached figures, the spreader of the invention is linked via a suitable computer application control system that can read from a database map of course attribute information as well as read the output of a tractor location tracking system.

As a preliminary step towards precision treatment of golf courses and turf-growing areas (generally described herein with reference to golf courses), a map is created of the course attributes using the methods described for agricultural fields in U.S. Pat. No. 6,606,542 and published US Patent Application No. 2002/0022929 (which are herein incorporated by reference) for a variety of sites on the course (the “site specific” method). Course attribute maps contain data that is collected from a field and converted into a format used to create application maps. The collected data of attributes includes course boundaries, soil sample information, obstacle information, aerial photos, topographic maps, grass species data, moisture, shade, turf health, pest infestation, various types of historical data pertinent to the management of a golf course, and other data relevant for the growing of grass and the various grass species found on a particular course. Course attribute maps may contain all or selected types of data. The data entered into the mapping system also includes product information that describes the qualities and application rates of treatment agents that are to be applied during a specified treatment session in addition to “as-applied” data collected from an application machine. Preferably, a library of treatment agents is uploaded or stored within the mapping system for menu-based selection of treatment agents that identifies products by trade name or other readily recognized label.

Once the data has been input to the mapping system, it is cleansed and validated. The cleansing process corrects any data errors and converts the data into a standard format. The validation process verifies the latitude and longitude of the data and allows a user to graphically verify the information. The cleansing and validation process also requires the user to assign a course location and customer information to the data. The data is then stored in a data storage system based on its latitude and longitude coordinates.

The next step is to retrieve the information from the data storage system. Each type of data uses a special data modeler to retrieve and convert the information. This allows the information to be converted into a special format that can be used to create application maps. Information regarding the treatment agent or agents to be applied are then used by the mapping system to determine how much of each treatment agent is required at each location on the course map. Similarly, historical treatment information can be correlated with turf health and infestation information to adjust the amount and quality of the applied treatment agents to prevent or avoid diseases or pest infestations that recur regularly or intermittently.

The final step is to convert the data into a two-dimensional grid format. The conversion process breaks the course map into multiple grid cells, where each cell contains data specific to that portion of the course. The information for each cell is then transformed from polygon or point data into a single surface or layer of data for the entire cell. The two-dimensional grid format of the course attribute maps allows the mapping system to more efficiently access the course data. The end result is a faster mapping system.

A suitable combination of software and application control hardware for use in the present invention with minor modifications is sold under the name FALCON II™, version 2.0 by the SOILTEQ division of AGCO located in Minnetonka, Minn. This software is sold as an “application controller” for farm management that allows granular or liquid treatment agents to be applied at a fixed or variable rate with or without a map of field attributes.

The modifications to the FALCON II software include a change in the dispersion pattern of granular treatments from the 15-35 m typically used in agriculture to the more controlled size of 3-10 m, usually about 4-6 m that would be useful for the limited widths found in a typical golf course. Additionally, the system is modified to use the change in GPS coordinates to calculate ground speed of the application tractor.

The hardware included with the commercial FALCON II package includes a display (LCD), a keypad with a removable media drive (e.g., a computer diskette is included but could also be modified to accept a writable CD-ROM, USB port, or firewire connection), a control node for connecting the discharge chute control plate as well as the belt drive motor on the spreader, a removable hard drive, and a central processing unit (CPU) in a rugged case. An operating system, such as a WINDOWS™ graphical operating system, resides on the hard drive and is used as the interface for control and display of the application process as well as for accepting input of the GPS location information. The hard drive is also used to store application rate and location information for the preparation of reports as well as historical analysis and comparison.

The spreader has preferably one or more bins for turf treatment agents that are gravity fed through a discharge opening to a movable belt for deposit on one or more rotary spreader plates. A particularly preferred spreader is a pull spreader model no. SMC512SSP sold by Simonsen Industries of Quimby, Iowa USA. In this spreader, a “V-shaped” bin holds the treatment agent with a gravity feed to a discharge opening whose area is controlled by an adjustable discharge plate that can slide open or closed to control the rate of discharge. If more than one bin is used, each discharge chute plate is assigned a separate identity or “node” for independent control by the application control system. The discharge chute allows treatment agent to be discharged onto a moving belt whose transport speed is controllable by a variable speed belt drive motor. The speed of this motor is operatively linked to the application control system. The belt delivers the treatment agent to one or more rotary plate spreaders for distribution behind the tractor in a fan-shaped cone. The shape of this distribution cone can be adjusted in arc by deflectors located adjacent the spreader plates and in distance by the rotational speed of the plates. Such adjustments are well within the existing level of skill in the art of those acquainted with rotary spreader devices.

Turning now to the drawings, utility tractor 1 is hitched to pulled spreader 2 in tractor bed 3 at a point located in front of rear tractor wheels 4 but behind front tractor wheels 5 and operator cab 6. As shown, both front tractor wheels 5 and rear tractor wheels 6 have a width of about 10 inches, a sidewall height of about 5 inches, and an aspect ratio of about 0.5. Forklift system 7 may be attached to the front of tractor 1 to facilitate the loading of spreader bin 8 with treatment agent. Bin 8 can be subdivided into two or more separate bins and provided with independently controlled discharge chutes, if desired, for simultaneous application of more than one treatment agent at independently controlled rates, e.g., a weed treatment agent with an insecticide or fungicide.

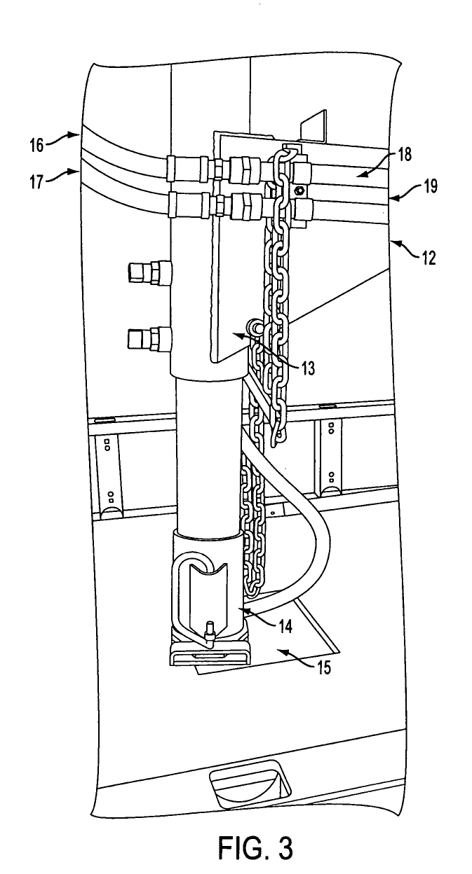

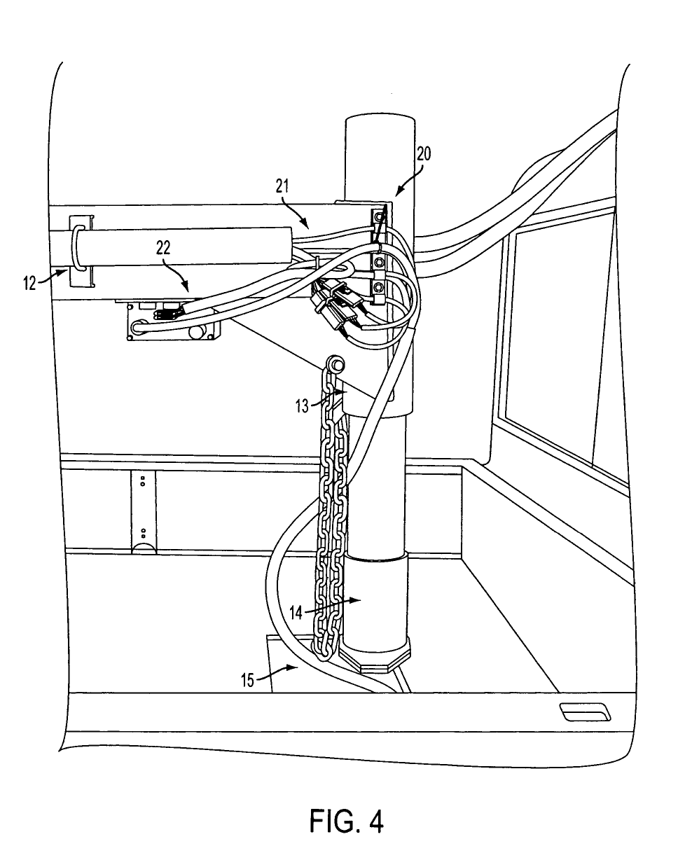

Pulled spreader 2 includes a pair of rear wheels 9 mounted on central support 10 that is welded or integrally secured to riser 11, bed extension 12, and vertically extendable support stand 13 with a first hitch coupling 14 located in the bottom thereof and configured to form a mated hitch coupling with second hitch coupling 15 in tractor bed 3, as discussed above. Hydraulic lines 16, 17 are secured to hydraulic coupling connections 18, 19 on support stand 13 (FIG. 3). As shown in FIG. 4, the opposite side of support stand 13 also provides an attachment support point for harness 20 electrical communication lines 21 that extend to the discharge chute slide 24, variable speed belt drive motor 25, and spreader plate rotation motors 26, 27 for connection to control node 22. Identification and control node 22 is programmed with information that identifies spreader 2 and its capabilities, components, and status to the maintenance control computer 23 as well as providing the logic control interface for controlling operation of spreader 2.

Spreader plates 28, 29 are rotated horizontally in opposite directions to disperse granulated treatment agent falling onto plates 28, 29 from belt 30. L-shaped throwing arms 31 are mounted onto plates 28, 29 to push on treatment agent granules as plates 28, 29 rotate. The rotational speed of plates 28, 29 should be adjusted to distribute granulated treatment agent in a cone having an arc within the range of 15-60° to a maximum spread suitable for the target area under treatment on the course, usually within the range of 2-10 m, and most often within the range of 3-7 m before the granules fall to earth.

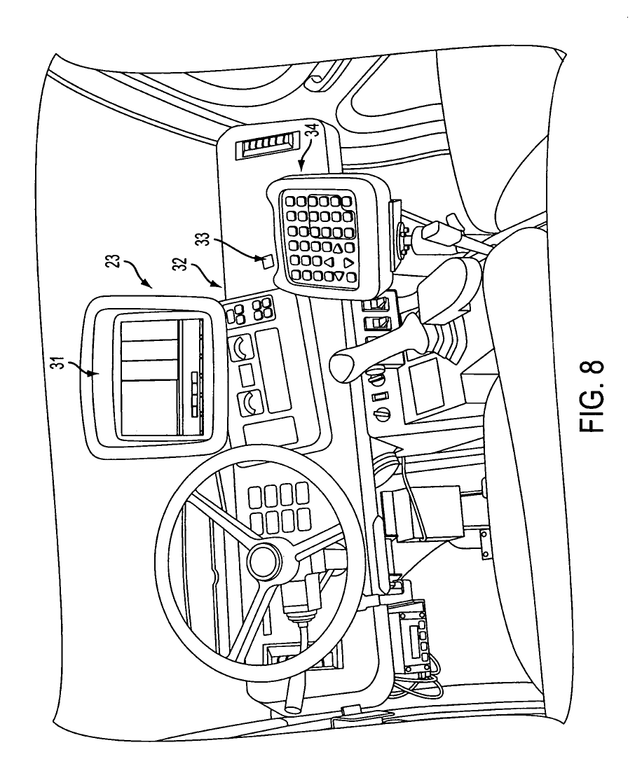

As shown in FIG. 8, application control computer system 23 includes display 31, computer 32 with a hard drive and CPU mounted therein, and keypad 33 having removable media drive 34 (diskette, CD writer, USB flash drive, and the like) mounted on the back of keypad 33. Computer system 23 is electronically coupled to control node 22 for computer control over the quantity and (if multiple bins of treatment agent are used) quality of the applied treatment.

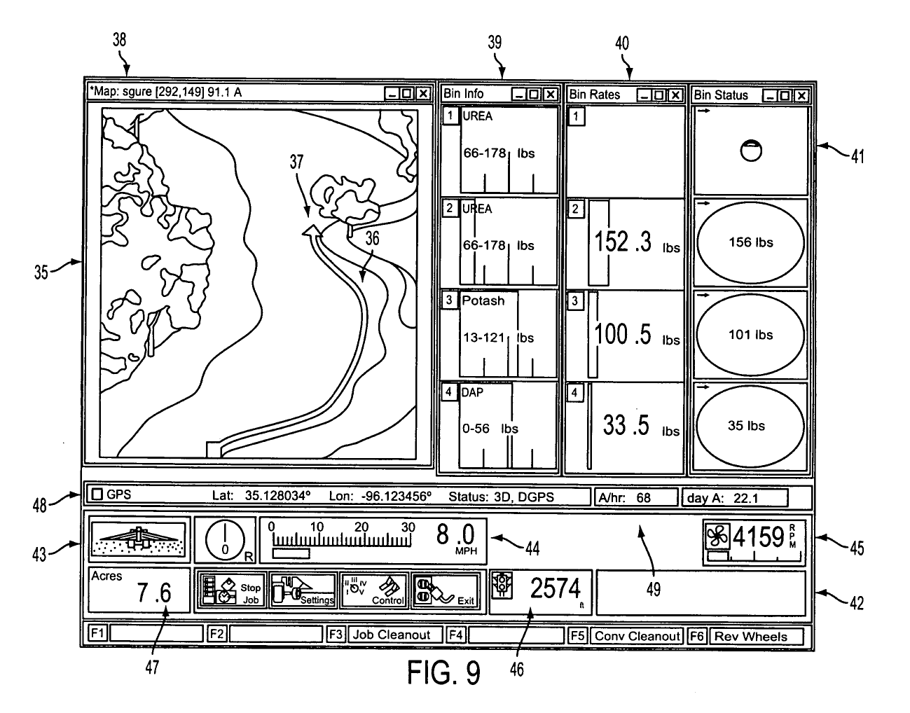

FIG. 9 shows a sample screen that might appear to an operator on display 31 while treating a target area. A graphical interface is used to display five separate virtual desktops that are tiled in layout on the same display screen. In the depicted instance, the treated area is a large field with five types of characteristics (virtual desktop 38) using a four binspreader (virtual desktop 39) that is applying treatment agent from only three of the bins (virtual desktop 40) with quantities of treatment agent remaining in each bin as shown in virtual desktop 41. The displayed information includes color-coded map 35 of the target area with a visual indicator of the treated area 36 and direction of travel 37. Virtual desktop 42 provides a graphical depiction 43 for tilt and yaw orientation, ground speed 44, spreader rotation speed 45, distance traveled 46, the acreage treated 47, latitude and longitude 48, and treatment rate 49.

1. A maintenance equipment system suitable for the precision maintenance of turf on a golf course, said system comprising:
a. a utility tractor having a plurality of wheels distributed at a front end and a rear end of said tractor,
b. a turf maintenance device hitched to said tractor at a location on said tractor sufficient to distribute weight of said maintenance device between said wheels and prevent damage to turf on said course,
c. a position location system that displays local position of said utility tractor relative to a treatment area and displays said location to an operator of said tractor, and
d. a maintenance control computer system that is in communication with said location system wherein said computer application control system (i) records position information in said target treatment area, (ii) correlates said position information with stored data that identifies the turf treatment needs at said location for said maintenance device, and (iii) sends control signals to said maintenance device for controlling operation of said maintenance device at said location.

2. A system according to claim 1 wherein said utility tractor comprises a hitch for said maintenance device that is located behind an operator cab and at a location above and between front and rear wheels on said tractor.

3. A system according to claim 1 wherein the wheels of said tractor have a width sufficient to prevent damage to turf on a golf course.

4. A system according to claim 1 wherein said maintenance device further comprises an identification node that is provides the maintenance control computer with information about said maintenance device.

5. A computer system according to claim 1 wherein maintenance device is selected from the group consisting of a granular chemical spreader, a liquid chemical sprayer, a mower, and a turf aerator.

6. A system for precision treatment of turf grass areas comprises:
a. a utility tractor having a plurality of wheels distributed at a front end and a rear end of said tractor of a width sufficient to prevent damage to turf grass.
b. a variable rate spreader hitchable to said tractor and comprising: (i) a storage bin having a discharge opening, and (ii) a movable transport belt that can be moved by a variable speed motor, wherein said transport belt is disposed below said discharge opening for transporting turf treatment agents discharged from said bin for dispersion onto a turf grass area,
c. a position location and display system that displays a local position of said utility tractor relative to a treatment area, and
d. a computer application control system that is in communication with said location and display system wherein said computer application control system (i) records position information in said target treatment area, (ii) correlates said position information with stored data that identifies the turf treatment needs at said location, and (iii) sends control signals to said discharge opening and/or said variable speed motor for varying the rate of turf treatment agent applied at said location.

7. A system according to claim 6 wherein said spreader is hitched to said tractor at a location sufficient to distribute weight from said spreader among the wheels of said tractor.

8. A system according to claim 7 wherein said tractor further comprises an operator cab and a rear bed, wherein said spreader is hitched to said tractor with a hitch coupling located in said bed.

9. A system according to claim 8 wherein said hitch coupling is located in said bed at a point above and between the front end wheels and the rear end wheels of said tractor.

10. A system according to claim 7 wherein each of the utility tractor wheels has a width sufficiently wide to provide a sufficiently high “footprint” at recommended inflation and maximum load to minimize or avoid damage to turf grass underneath the tire while said tractor is used to pull a loaded spreader.

11. A system according to claim 10 wherein each of the utility tractor wheels has a width within the range from about 8-14 inches.

12. A system according to claim 10 wherein each of the utility tractor wheels has a sidewall height within the range from about 4-8 inches.

13. A system according to claim 10 wherein each of the utility tractor wheels has an aspect ratio within the range from about 0.35 to about 1.

14. A system according to claim 13 wherein each of the utility tractor wheels has an aspect ratio within the range from about 0.4 to about 0.75.

15. A method for treating areas of grass found on a golf course, said method comprising:
applying at least one turf treatment agent in a target location at a rate and over an area corresponding to stored computer information that identifies the course attributes at said target location, wherein application of said turf treatment agent in said area is controlled by a computer system responding to location information that controls the quantity of the applied turf treatment agent thru a spreader controllably linked to said computer and based on (a) location information and (b) a map of course attributes that is stored within said computer.

16. A method according to claim 15 wherein said at least one turf treatment agent is applied using the system of claim 6.

17. A method according to claim 16 wherein said at least one turf treatment agent is applied using an application and spreading system comprising:
a. a utility tractor having a plurality of wheels distributed at a front end and a rear end of said tractor, wherein each of the utility tractor wheels has a width sufficiently wide to provide a sufficiently high “footprint” at recommended inflation and maximum load to minimize or avoid damage to turf grass underneath the tire while said tractor is used to pull a loaded spreader,
b. a variable rate spreader towed behind said tractor and comprising a storage bin having a gravity fed discharge opening, a transport apron moved by a variable rate motor and located below said discharge opening for transporting turf treatment agents discharged from said bin to a rotary spreader,
c. a position location and display system that displays local position relative to a target treatment area to an operator driving said utility tractor,
d. a computer application control system that is in communication with said location and display system wherein said computer application control system (i) records position information in said target treatment area, (ii) correlates said position information with stored data that identifies course attributes at said location, and (iii) sends control signals to said discharge opening and/or said variable rate motor for varying the amount of turf treatment agent applied at said location.

18. A method according to claim 17 wherein said stored data comprises course boundaries, soil sample information, obstacle information, aerial photos, topographic maps, grass species data, moisture, shade, turf health, pest infestation, various types of historical treatment data pertinent to the management of a golf course, or other data relevant for the growing of grass and the various grass species found on a particular course.

19. A method according to claim 17 wherein said stored data comprises course boundaries, soil sample information, grass species data, turf health, pest infestation, and historical treatment data pertinent to the management of a golf course.

20. A method according to claim 17 wherein each of the utility tractor wheels has a width within the range from about 8-14 inches.

21. A system according to claim 20 wherein each of the utility tractor wheels has a sidewall height within the range from about 4-8 inches.

22. A system according to claim 17 wherein each of the utility tractor wheels has an aspect ratio within the range from about 0.35 to about 1.

23. A system according to claim 22 wherein each of the utility tractor wheels has an aspect ratio within the range from about 0.4 to about 0.75.
